(19) United States
(12) Patent Application Publication
(10) Pub. No.: US 2014/0162729 A1
(43) Pub. Date: Jun. 12, 2014

(54) MOBILE DEVICE ACCESSORY HAVING A LOW POWER DRAIN ELECTRONIC DISPLAY

(71) Applicant: Bensussen Deutsch & Associates, Inc, Woodinville, WA (US)

(72) Inventors: Alexander John Garden, Bellevue, WA (US); Steven M. Cramer, Redmond, WA (US)

(73) Assignee: Bensussen Deutsch & Associates, Inc, Woodinville, WA (US)

(21) Appl. No.: 14/101,007

(22) Filed: Dec. 9, 2013

Related U.S. Application Data
(60) Provisional application No. 61/735,508, filed on Dec. 10, 2012.

(51) Int. Cl. H04M 1/02; H04B 1/38

(52) U.S. Cl. CPC H04M 1/0266; H04B 1/3888
USPC 455/566

(57) ABSTRACT

An accessory for processor-based mobile devices is selectively securely attachable to the mobile device and at least partially wraps around at least one edge of the mobile device, so that a photo-reflective dipolar electronic display incorporated into the outer shell of the accessory can provide a visual platform for sustained image retention with negligible power consumption. Content (e.g., image data) is transmitted wirelessly from the mobile device to the accessory. Electronic and/or electrical components for receiving, directing, decrypting, and displaying images can be incorporated into a resilient sleeve, integrated into a hard shell case, or a combination of the two. Content can originate in the mobile device, or at a remote content server, to periodically update an image on the accessory.

### BACKGROUND

1. Technical Field

The present disclosure generally relates to accessories for mobile computing devices.

2. Description of the Related Art

There continues to exist a large consumer market for personalized items, for example, vanity license plates, monogrammed clothing, greeting cards and calendars bearing personalized photographs, custom cell phone ring tones, personalized “wallpaper” for desktop computer monitors, and many types of fashionable accessories. Mobile phone accessories such as cases, are typically made of metal, plastic, rubber, leather, or combinations of these materials. Mobile phone cases are usually considered to be primarily protective devices, which have a limited capacity for personalization. For example, a mobile phone case can bear a static (fixed) graphic image of a user's choice such as a team logo, a static photo image, or a designer color, pattern, or motif. If the user desires to change the appearance of the mobile device case, the user can purchase a new case, or possibly decals, and the like.

### BRIEF SUMMARY

Each of the above described options has a fixed appearance, not a variable appearance. Consumers may welcome a mobile phone case that could instantly project a different image of their choice at any time, on demand.

Electronic paper display technologies use photo-reflective array elements built on a flexible plastic substrate. Because the array elements reflect light instead of emitting light, the array elements can hold static text and images indefinitely while consuming only a very small amount of power. Another advantage is that photo-reflective displays are more visible in direct sunlight than their light-emitting counterparts. Types of electronic paper displays include electrophoretic displays, electrowetting displays, and electrochromic displays. One example of an early generation commercially-available e-ink display is the Kindle

DX® e-reader, which downloads a new image for decorative display on the display screen whenever the device is idle. Some mobile phones also incorporate e-ink technology into device displays or keypads.

An accessory for processor-based mobile devices described herein is selectively securely attachable to the mobile device and at least partially wraps around at least one edge of the mobile device. A photo-reflective dipolar electronic paper display incorporated into the outer shell of the accessory can provide a visual platform for sustained image retention for an extended period of time without drawing electrical power. Images are transmitted wirelessly from the mobile device to the accessory via a short-range RF communication path. Electronic and/or electrical components within the accessory can include a drive circuit, one or more power transducers for harvesting energy from external sources, one or more processors, a wireless receiver, an RF antenna, encryption circuitry, and the like. Electronic and/or electrical components can be incorporated into a resilient sleeve, integrated into a hard shell case, or a combination of the two. Images can originate in the mobile device, or at a remote content server, for selection by a user, so that a personalized appearance of the mobile device can be periodically updated by changing the image on the accessory. Images originating at the remote content server can include commercial images or advertising.

An accessory for processor-based mobile devices may be summarized as including: a body that is selectively securely attachable to a processor-based mobile device; a photo-reflective dipolar electronic display carried by the body and which in use at least partially wraps about at least one edge of the processor-based mobile device; a wireless receiver and at least one antenna carried by the body, the wireless receiver operable to at least receive wireless communications from the processor-based mobile device at least when the body is securely attached to the processor-based mobile device, the wireless communications including image data for display via the photo-reflective dipolar electronic display; a drive circuit communicatively coupled between the wireless receiver and the photo-reflective dipolar electronic display to at least drive the photo-reflective dipolar electronic display in response to received image data; and a power transducer carried by the body and electrically coupled to supply power to at least one of the drive circuit or the photo-reflective dipolar electronic display and which receives power from a source external from the accessory.

The accessory for processor-based mobile devices may further include a hard shell case that is received about a portion of the resilient silicone sleeve and the processor-based mobile device.

The accessory for processor-based mobile devices may further include a resilient silicone sleeve that is resiliently secured to about a portion of the processor-based mobile device, and about which the hard shell case is at least partially received.

The accessory for processor-based mobile devices may further include a visual indicator carried by the body and selectively actuatable by the power transducer to indicate when the power transducer is producing charge.

The accessory for processor-based mobile devices may further include a visual indicator carried by the body and selectively actuatable by the wireless receiver to indicate when image data is being received by the photo-reflective dipolar electronic display.

The accessory for processor-based mobile devices may further include a wireless transmitter communicatively coupled to the at least one antenna.

The body may include a resilient silicone sleeve. At least the wireless receiver and the drive circuit may be encapsulated in the resilient silicone sleeve. The body may be a hard shell case having a base and a number of resilient portions extending from the base. The body may have a base and a number of sides extending at least approximately from the base which deliminate an interior of the body. The at least one photovoltaic cell may be positioned in the interior of the body. The at least one photovoltaic cell may be exposed to light only when the accessory is not attached to the processor-based mobile device. The power transducer may include at least one photovoltaic cell to harvest energy from light in an ambient environment. At least the wireless receiver and the drive circuit may be encapsulated in the hard shell case or in the body. The power transducer may include an inductive coil to inductively receive power from the processor-based mobile device. The power transducer may include a rectifier circuit and a capacitor, coupled to the antenna to harvest energy from the wireless communications transmitted via the processor-based mobile device. The photo-reflective dipolar electronic display may be an e-paper display which retains an image for an extended period of time without drawing electrical power.

An after-market case for mobile electronic devices may be summarized as including: a body that wraps around at least one pair of opposed edges of a mobile electronic device to selectively attach the case to, and detach the case from, the mobile electronic device; a power supply integral with the case; a wireless receiver integral with the case; and an array of photo-reflective elements communicatively coupled to the power supply and the wireless receiver, the array of photo-reflective elements selectively operable to display one of a number of static images in response to signals received via the wireless receiver, the images displayed for periods of time following an application of power from the power supply to the photo-reflective elements without further application of power during the periods of time.

The after-market case for mobile electronic devices may further include a decryption integrated circuit communicatively coupled to the wireless receiver to decrypt the signals received via the wireless receiver.

The body may include one or more of a hard shell and a number of resilient portions. The power supply may include at least one transducer that harvests energy from a source external to the case. The photo-reflective elements may be electrophoretic elements. The photo-reflective dipolar electronic display may be a non-volatile display capable of retaining an image for an extended period of time without drawing electrical power.

A processor-based mobile apparatus having a personalized appearance that is periodically updatable may be summarized as including: a smart phone; a resilient sleeve that at least partially wraps around the smart phone, the sleeve equipped with an integral low-power supply; an array of photo-reflective elements integral to a surface of the resilient sleeve; a display driver; and a wireless receiver electrically coupled to the array via the display driver, the receiver accepting image data from the smart phone, and directing the image data to the display driver for display of a selected image on the array when the array is energized by the low-power supply and, when the array is not energized, for sustained retention of the displayed image to project a personalized appearance on a surface of the resilient sleeve.

The smart phone may transmit encrypted image data to the wireless receiver. The display driver may decrypt the image data prior to display of the image on the array.

A method of adjusting an external appearance of a processor-based mobile device may be summarized as including: partially wrapping around at least one edge of the processor-based mobile device, and including a power transducer, a drive circuit, a wireless receiver, and an antenna; receiving power from a source external to the accessory, via the power transducer; receiving image data from the mobile device via the antenna and wireless receiver; displaying the received image data on an array of photo-reflective dipolar electronic display elements carried by the accessory, in response to signals from the drive circuit, when power is applied to the array by the power transducer; and sustaining the image data on the array of photo-reflective dipolar electronic display elements after power is removed from the array.

The method of adjusting an external appearance of a processor-based mobile device may further include decrypting the image data via an integrated circuit of the accessory.

The receiving may include receiving encrypted image data from the mobile device via the antenna and wireless receiver. The receiving image data from the mobile device may include receiving personalized image data provided by a user. The receiving image data from the mobile device may include image data captured using a camera of the mobile device. The receiving image data may include receiving other image data not captured using a camera of the mobile device. The receiving image data may include receiving image data via an application executing on the mobile device. The receiving image data may include receiving advertising image data pushed to the mobile device. The receiving image data may include receiving advertising image data pulled to the mobile device.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements, and have been solely selected for ease of recognition in the drawings.

FIG. 1A is a pictorial perspective view of a smart phone and a hard shell case smart phone accessory according to an exemplary embodiment described herein.

FIG. 1B is a pictorial perspective view of an underside of the smart phone and an underside of the smart phone case, featuring a customized appearance that is periodically updatable.

FIG. 2 is an exploded perspective view showing electronic and/or electrical components of a smart phone accessory described herein.

FIG. 3 shows an embodiment in which energy harvesting devices are mounted on opposite ends of the exterior of the smart phone accessory body, as described herein.

FIG. 4A is a pictorial perspective view of a smart phone in a resilient silicone sleeve that wraps around the edges of the smart phone.

FIG. 4B is a pictorial perspective view of a smart phone in a hybrid case smart phone accessory, according to one embodiment.

FIG. 5 is a flow diagram showing a method of making a smart phone case that sustains a received image on a photo-reflective dipolar electronic display, according to one illustrated embodiment.

FIG. 6 is a functional block diagram showing components of a networked support system within which a portable electronic device (e.g., smart phone) and an accessory (e.g., case) may be deployed in accordance with embodiments described herein.

FIG. 7 is a top plan view of a smart phone display that includes one or more applications programs for use with the smart phone accessory described herein.

FIG. 8 is a functional block diagram showing an arrangement of, and interconnections between, electronic and/or electrical components within an accessory for processor-based mobile devices.

FIG. 9 is a flow diagram describing a method of adjusting an external appearance of a processor-based mobile device using an accessory that displays received image data.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with smart phones, computer systems, server computers, and/or communications networks have not been shown or described in detail to avoid unnecessarily obscuring descriptions of the embodiments.

Unless the context requires otherwise, throughout the specification and claims which follow, the word “comprise” and variations thereof, such as “comprises” and “comprising,” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

As used in this specification and the appended claims, the term “content” includes images, graphics, text, or other information that can be communicated to a destination for display. An embodiment of a content server may be an image server for handling image data, which may include generating, storing, maintaining, processing, or communicating the image data.

The headings and Abstract of the Disclosure provided herein are for convenience only and do not interpret the scope or meaning of the embodiments.

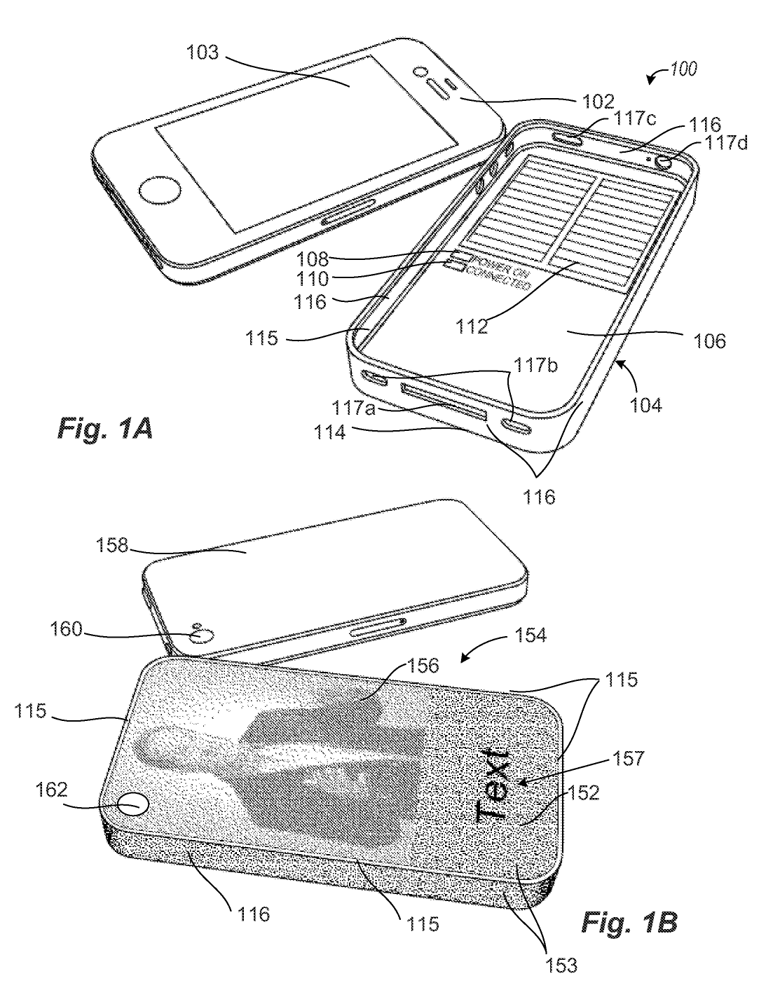

FIGS. 1A and 1B show an accessory for use with processor-based mobile devices or portable electronic devices in the form of an after-market case 100. The case 100 may, for example, be sized and configured for use with a smart phone 102 having a standard planar display screen 103. Components of the case 100 are capable of wirelessly receiving images from a source for display on one or more surfaces of the case 100. Thus, the case 100 functions as a non-planar, or 3-D, customized display vehicle. The standard planar display screen 103 of the smart phone 102 or other portable electronic device may be configured as a touch screen that accepts user input using a finger, stylus, or other pointing device. Input to the smart phone 102 may also be received by typing, speaking, or pointing using a built-in or external track pad, mouse, track ball, or other similar input device (not shown).

Interior parts of the case 100 shown in FIG. 1A that may, in some implementations, be visible to a user include a body 104, an inside face plate 106, a power-on visual indicator light 108, a connectivity visual indicator light 110, and a photovoltaic cell panel 112. The body 104 has a base 114 and a number of case sides (four shown, collectively 116), extending at least approximately from the base 114, which deliminate an interior of the body 104. The base 114 connects to the case sides 116 at case edges 115.

The body 104 is generally selectively securely attachable to the smart phone 102 or other portable electronic device, such that the body 104 wraps around at least one pair of opposed case edges 115 of the smart phone 102. The body 104 is generally customized to a specific make and model so as to accommodate the outer dimensions thereof as well as built-in components or access to buttons or connectors on various surfaces of the portable electronic device 102. For example, openings in the body 104 (four shown, collectively 117) can include a connector opening 117a through which a connector of a cable (e.g., USB cable, Apple® 30-pin, or 8-pin cables) can be selectively attached to the smart phone 102. Also for example, a pair of sound openings 117b may align with speakers and/or microphones to allow sound to pass. As a further example, one or more button openings 117c (one shown) may align with respective buttons or keys providing access to such from an exterior of the case 100. As yet an even further example, a headset plug opening 117d may align with a headset plug port, allowing a plug of a headset to be attached to the smart phone 102.

The photovoltaic cell panel 112, including at least one photovoltaic cell, is shown positioned in the interior of the body 104, which allows exposure of the photovoltaic panel 112 to a light source only when the smart phone 102 is not attached to the case 100. The photovoltaic panel 112 is preferably flexible so as to conform to the shape of the case 100. The photovoltaic panel 112 is generally capable of harvesting energy from direct or indirect sunlight or from indoor sources of light such as, for example, fluorescent light fixtures. The power-on visual indicator light 108 alerts the user that the case 100 is energized and consuming electric power (discharging), or that the case is charging. The connectivity visual indicator light 110 alerts the user that the case 100 is receiving data from a source (e.g., the smart phone 102 or other portable electronic device) through a wireless communication channel.

FIG. 1B also shows a smart phone back 158, which may house some smart phone components, such as a camera lens 160. The case 100 preferably accommodates the camera lens 160 by providing a camera lens opening 162 in the case back 152 aligned with the camera lens 160 to prevent obstruction of the camera lens 160 by the case back 152. When the case 100 is inverted as shown in FIG. 1B, a case back 152 is visible, as well as a representative one of the case sides 116. A flexible display 153 extends along at least a portion of the case back 152 and case side(s) 116. The flexible display is selectively operable to display image data associated with at least a portion of a digital image 154. The digital image 154 may include one or more pictures 156 and/or text 157, logos (not shown) or graphics (not shown) including various patterns. The digital image 154 appears on the case back 152 and preferably on at least one case side 116. The digital image 154 can be changed by downloading different content in the form of image data that is transmitted via a source, for instance, via the smart phone 102 or other portable electronic device.

The digital image 154 can be formed by the flexible display 153 that may at least partially wrap around at least one of the case edges 115. The case edges 115 wrap around respective edges of the smart phone 102 or other portable electronic device, as shown in FIG. 1 B. The flexible display 153 can cover, for example, all five faces of a rectangular embodiment of the case 100, thereby conforming to the exterior shape of the smart phone 102 or other portable electronic device. Such a 3-D, or non-planar, display 153 may be achieved via use of one or more flexible “electronic paper” display technologies. Electronic paper generally employs a photo-reflective dipolar electronic display technology as described above. Commercially available electronic paper displays typically have been used in place of the standard planar display screen 103 of a processor-based mobile device, such as an e-reader (e.g., Amazon Kindle®). In contrast, embodiments taught herein incorporate electronic paper display technology into a skin of a removable accessory. Such an accessory includes electronic and/or electrical components for interactively receiving and displaying user-specified or user-customized image data on multiple surfaces of the accessory.

The ability to display customized, changeable images can transform a case for a portable electronic device into a dynamic personalized form of expression that allows Individual users to upload different personalized images or messages on demand. Such images or messages may include portraits of children, family members, pets, friends, vacation photos, original artwork, and the like. The case 100 thus becomes a mobile vanity item that bears individualized “wallpaper” or a configurable canvas that can be changed by the user at any time.

The ability to display customized, changeable image data also potentially transforms a case into a dynamic branded merchandise item. Whereas traditional branded merchandise such as sporting goods or team clothing, hats, logo-bearing gadgets, trinkets, and the like are typically embossed with static graphic images, incorporating electronic paper into an accessory such as the case 100 for the smart phone 102 or other portable electronic device yields a flexible, powerful advertising platform. Thus, instead of purchasing a case bearing a single image of a team mascot or logo, a user having the case 100 can display an image of a football team logo during football season, and change to a basketball team logo during basketball season. Or, the user can access and display a new image every day, or whenever a new image is desired.

The ability to display customized, changeable images also potentially transforms a case into a vehicle for corporate communication. For example, corporations that issue smart phones 102 or other portable electronic devices to their employees can broadcast customized messages for display on the case back 152 and case sides 116. Such customized messages can include, for example, advertisements of newly-released products. Image data may be pushed to the case 100 via the smart phone 102. Alternatively or additionally, the smart phone 102 may pull image data from a remote source for display via the case 100.

The ability to display customized, changeable images also potentially transforms a case into a platform for optionally communicating information about media that is being played on the portable electronic device (e.g., smart phone, cellular phone, personal digital assistant, tablet computer, lap top computer). The media may, for example, take the form of music, electronic games, movies or video, or other software application modules currently running, executing, or otherwise active). For example, during, or for some time after a user plays a music recording on the portable electronic device, corresponding album cover art can be simultaneously displayed on the case 100. Similarly, during, or for some time after a user runs a video game application on the smart phone 102 or other portable electronic device, a graphic image relating to the game can be displayed on the case 100.

Alternatively, some combination of commercial content (e.g., advertisements, graphics, logos, images), advertisements, and personalized content (e.g., images, text, patterns) can be displayed on the case 100.

A case 100 for portable electronic devices is an excellent choice for an advertising platform. The case 100 will necessarily be within short range of a mobile device, the portable electronic device (e.g. smart phone 102). Such makes possible low-power wireless communications (e.g., Bluetooth™, WI-FI, IEEE 802.11 compliant protocols) to facilitate communication of image data. Image data may include advertisements, licensed commercial images, logos, trademarks, text, slogans, etc. Images projected by the flexible display 153 of the case 100 are likely to be at least partially visible most of the time, especially portions of the image that cover the case sides 116. Because a photo-reflective dipolar electronic display will continue to retain the image after power is turned off, the image remains visible even when the portable electronic device is not in use.

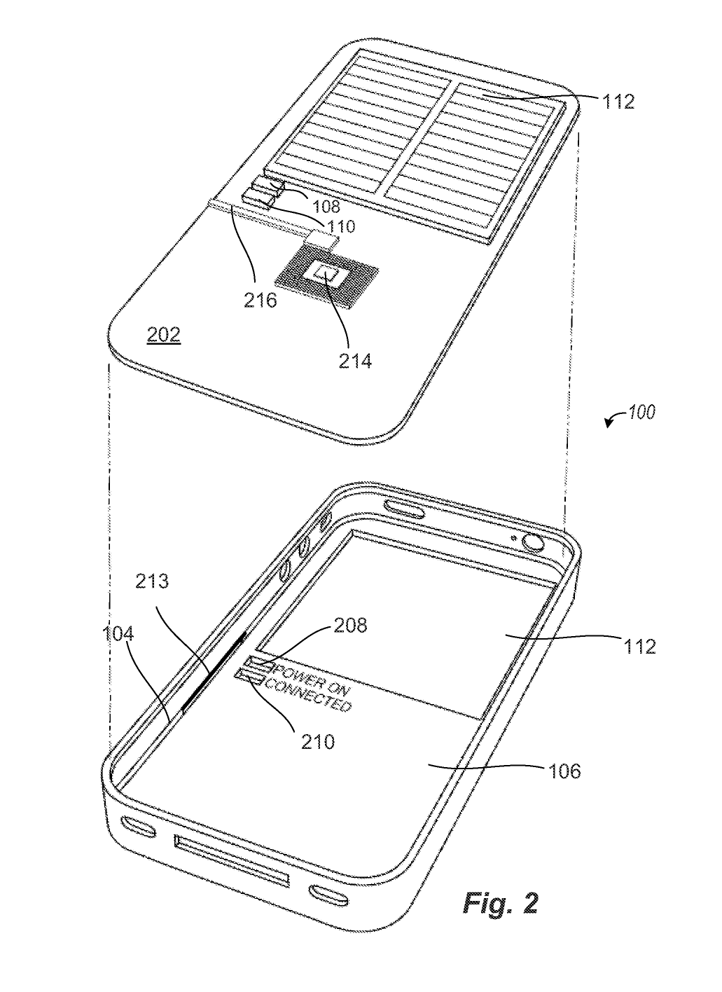

FIG. 2 shows the case 100, in which a circuit board 202, normally encapsulated in the hard shell portion of the case 100, is shown as having been removed from underneath the inside face plate 106, leaving the inside face plate 106 in the case 100. Unlike existing cases for portable electronic devices, the case 100 is itself a mobile electronic peripheral device. The inside face plate 106 of the case 100 may optionally include various openings, e.g., 208, 210, and 212 through which electronic and/or electrical components attached to the circuit board 202 may be visible or exposed. For example, the power-on visual indicator light 108, the connectivity visual indicator light 110, and the photovoltaic cell panel 112, respectively, may be exposed. Alternatively the case 100 or portion(s) thereof may be transparent or sufficiently translucent to render these electronic or electrical components visible.

The hard shell portion of the body 104 of the case 100 can encapsulate an antenna. The antenna may take any of a variety of forms of, for example, a strip line radio frequency (RF) antenna 213. The strip line RF antenna 213, which is shown in FIG. 2 as a straight conducting element aligned with a case edge 115, can generally assume any shape

The circuit board 202 may carry various electronic and/or electrical or electrical components. For example, the circuit board 202 may carry the power-on visual indicator light 108, the connectivity visual indicator light 110, and/or the photovoltaic cell panel 112. The circuit board 202 may additionally, or alternatively, carry an integrated circuit module 214 and an integrated circuit module connector 216. The integrated circuit module 214 can include integrated circuit chips such as, for example, various types of processors, drive circuits, nontransitory processor-readable storage media, wireless receiver signal processing hardware, and decryption hardware as described below in more detail. The integrated circuit module 214 can be a custom system-on-chip (SOC) device that serves as a platform for, and provides interconnects between, these various integrated circuits. The integrated circuit module connector 216 provides selectable electrical coupling between the strip line RF antenna 213 and the integrated circuit module 214.

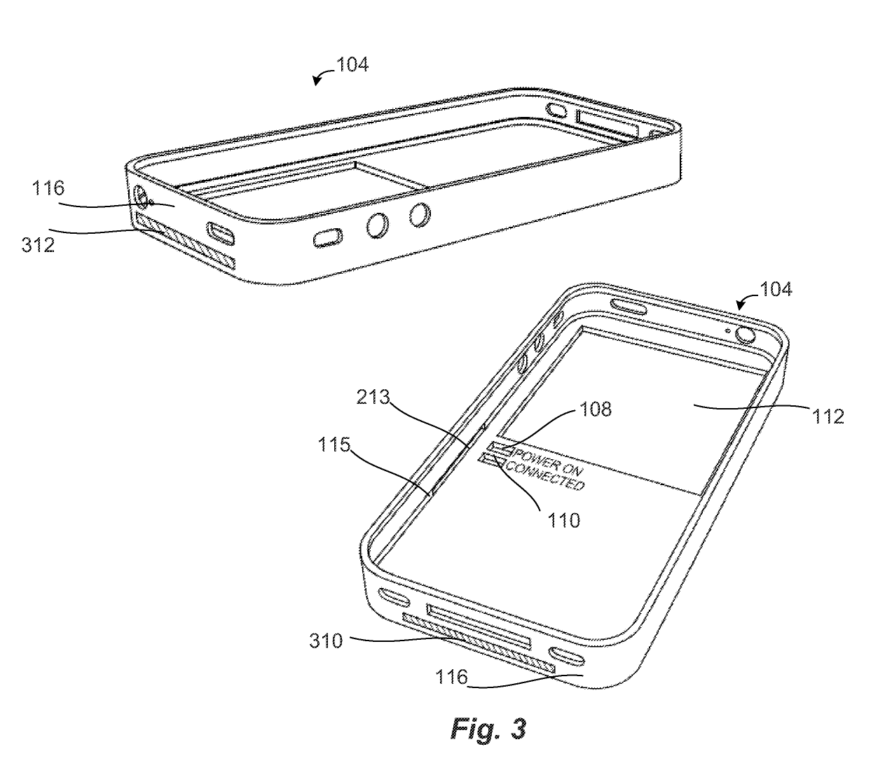

With reference to FIG. 3, according to one exemplary embodiment, one or more exterior photovoltaic cell panels 310 and 312 can be mounted on the exterior of the body 104, for example, on the case sides 116 at either end of the body 104. Exterior photovoltaic cell panels 310, shown as mounted at the bottom end of the body 104, and 312, shown as mounted at the top end of the body 104, allow charging electrical components of the case, including the display, whether or not the smart phone 102 or other portable electronic device is in or out of the case 100. Such an approach may disadvantageously reduce some of the image display area which would otherwise be available on the sides 116 of the case 100, for example, at the ends of the body 104.

The body 104 of the case 100 is shown in FIG. 1A-FIG. 3 as a hard shell case.

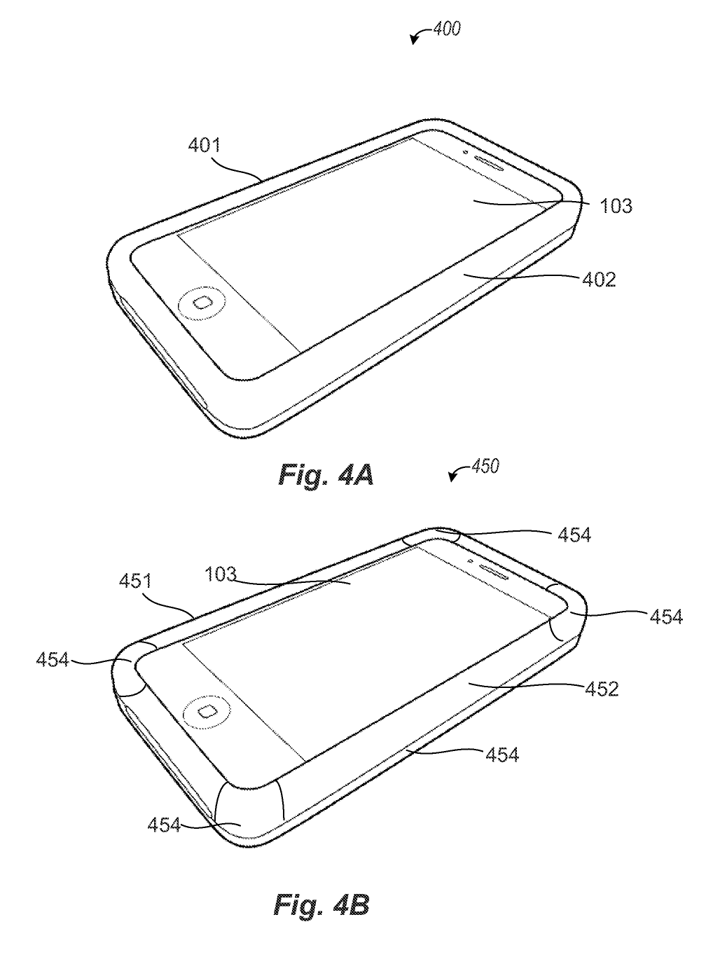

FIG. 4A shows an exemplary embodiment of a soft case 400 in which the smart phone 102 or other portable electronic device is placed in a soft case body 401. The soft case body 401 can be made of a pliable and/or resilient material. The soft case body 401 may, for example, take the form of a resilient silicone sleeve 402. The resilient silicone sleeve 402 serves generally to protect the smart phone 102 from damage, for example, to prevent breakage of the standard planar display screen 103. The resilient silicone sleeve 402 may be dimensioned such that the interior dimensions of the resilient silicone sleeve 402 are slightly smaller than the outer dimension of the smart phone 102. Thus, the resilient silicone sleeve 402 is stretched and retained under elastic force when the resilient silicone sleeve 402 is attached to the smart phone 102. Using electronic paper, images can generally be displayed by photo-reflective elements integral to, or attached to, a surface of either the resilient silicone sleeve 402 or the hard shell case 100. While described as silicone, other elastomer or resilient materials may be used to form a suitable sleeve.

FIG. 4B shows an exemplary embodiment of a hybrid case 450. A hybrid case body 451 may include some portions that are resilient portions 452 while other portions are hard shell portions 454. For example, as depicted in FIG. 4B, the corners of the hybrid case 450 can be implemented as hard shell portions 454, while the straight sides are implemented as resilient portions 452. Alternatively, or in addition, the base of the hybrid case 450 may be implemented on a hard shell portion 454 while the edges and/or sides extending from the base are implemented as resilient portions 452.

In another alternative, a two-part hybrid case may include a resilient portion in the form of the resilient silicone sleeve 402 to be secured directly to the smart phone 102 to form an interior of a hybrid case, and a hard shell portion in the form of a hard shell body 104 to be secured directly to the resilient silicone sleeve 402 to form an exterior of the two-part hybrid case 450. The hard shell body may have interior dimensions sized to closely receive (e.g., press fit, interference fit) the resilient silicone sleeve 402. The hard shell body may be sufficiently resilient to be slightly deformed as receiving the resilient silicone sleeve and thereby elastically retaining the resilient silicone sleeve.

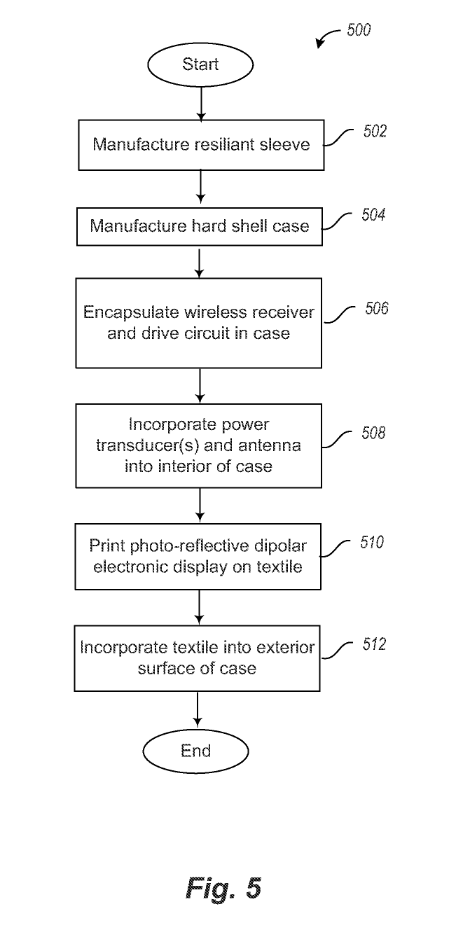

FIG. 5 shows a method 500 of making such a two-part hybrid case, to be carried out by a manufacturer.

At 502, the manufacturer creates an interior resilient silicone sleeve 402, for example, by an injection molding process. Circuitry including at least a wireless receiver and a drive circuit can be encapsulated in the resilient silicone sleeve 402. At 504, the manufacturer creates an exterior hard shell body 104. The hard shell body 104 may be made of a hard plastic, which can also be formed by injection molding. Or, the hard shell body 104 may be made of metal such as an aluminum alloy, which may be cast, rolled, and/or machined. The hard shell body should have sides that elastically deform to selectively removingly receive and retain the interior resilient silicone sleeve.

At 506, circuitry can be attached, as in the exemplary embodiment shown in FIG. 2, to the circuit board 202 inside the hard shell case body 104, for example, as components of the integrated circuit module 214.

At 508, one or more power transducers, such as the photovoltaic cell panel 112, and the strip line RF antenna 213 can be incorporated into the interior surface of the hard shell case body 104. Components can be incorporated by attachment (e.g., adhesive, fasteners), or by insertion into slots or pockets formed in the body 104 or in the resilient silicone sleeve 402 following the molding process.

At 510, an array of photo-reflective dipolar elements can be printed onto a flexible textile, so that, in 512, the flexible textile bearing the array of photo-reflective elements can be incorporated into or mounted on the exterior surface of the case back 152.

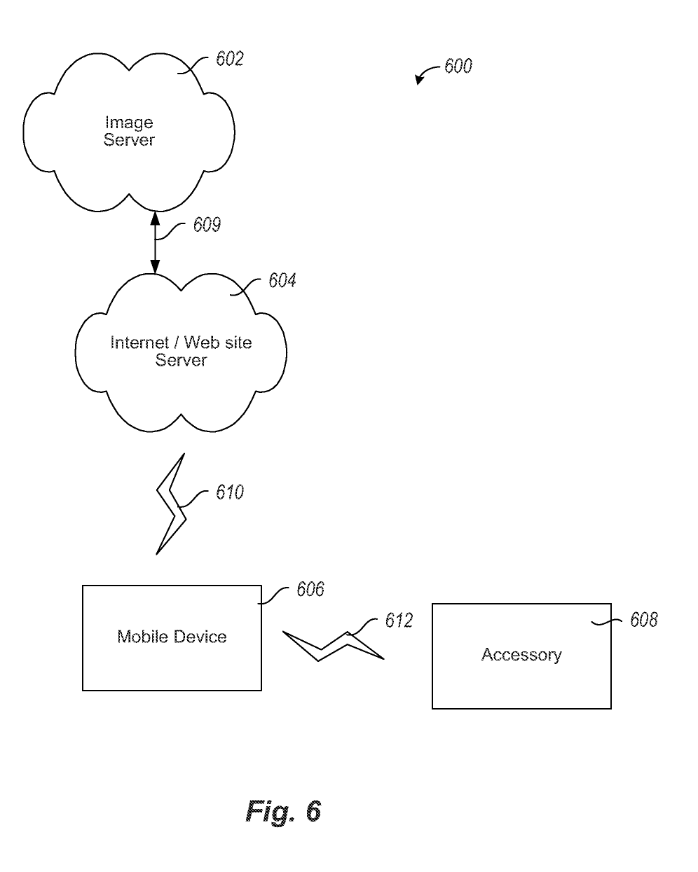

FIG. 6 illustrates an accessory configuration and support system 600 that supports use of an accessory 608 for a portable electronic device 606, such as the various cases described herein. The accessory configuration and support system 600 includes, but is not limited to: a content server 602, a network server such as an Internet/Web site server 604, communicatively coupled via the processor-based mobile device 606 to the accessory 608.

The content server 602 and the Internet/Web site server 604 can be server computers located anywhere. For example, the content server 602 and the Internet/Web site server 604 can be at remote locations with respect to the processor-based mobile device 606, consistent with a cloud computing arrangement. The Internet/Web site server 604 can be located at a server farm where a physical communication path 609 between the two servers is likely to be available (e.g., a hard-wired or fiber-optic path), allowing fast and secure transmission of image data. The Internet/Web site server 604 can be used to actively manage and download images, including licensed images for sale to smart phone users 702. Additionally or alternatively, the Internet/Web site server 604 can be used to actively manage and download the user's own images that may have been saved to a cloud-based server. The processor-based mobile device 606 can take the form of the smart phone 102 described above. Alternatively, the processor-based mobile device 606 can be a laptop computer, a tablet computer, a cell phone, a smart camera, a global positioning system (GPS) device, or other similar portable electronic device that includes capability to receive and transmit digital image data.

A relatively long-range wireless communication path 610 permits selectively communicatively coupling the Internet/Web site server 604 to the mobile device 606. The mobile device 606 is typically equipped with one or more relatively long-range RF antennas and circuitry (e.g., transceiver) for relatively long-range communications with, for example, cell towers, WI-FI providers, or wide-area coverage mobile Internet services (e.g., those compatible with 3 G or 4 G standards).

A relatively short range wireless communication path 612 permits selective communicative coupling of the accessory 608 to the processor-based mobile device 606. The mobile device 606 is typically equipped with one or more relatively short-range RF antennas and drive circuitry (e.g., receiver, transceiver) for relatively short-range communications via the short-range wireless communication path 612. The processor-based mobile device 606 may establish relatively short-range communications with the circuitry of the accessory 608, for example, compliant with the Bluetooth™ protocols. The processor-based mobile device 606 may additionally establish wireless communications with one or more intermediary devices (e.g., vehicle head unit), compliant with various wireless protocols (e.g., IEEE 802.11).

The content server 602 and/or the Internet/Web site server 604 can be capable of processing and/or encrypting image data available for download to the processor-based mobile device 606. Alternative or additional content security during image delivery can be provided at various points within the accessory configuration and support system 600. For example, security can be managed by the content server 602, by the Internet/Web site server 604, by a security chip or software module in the processor-based mobile device 606, by a security chip or software module in the accessory 608, and/or by one or more security gateways installed in the wireless communications paths 610 or 612 to ensure secure connectivity.

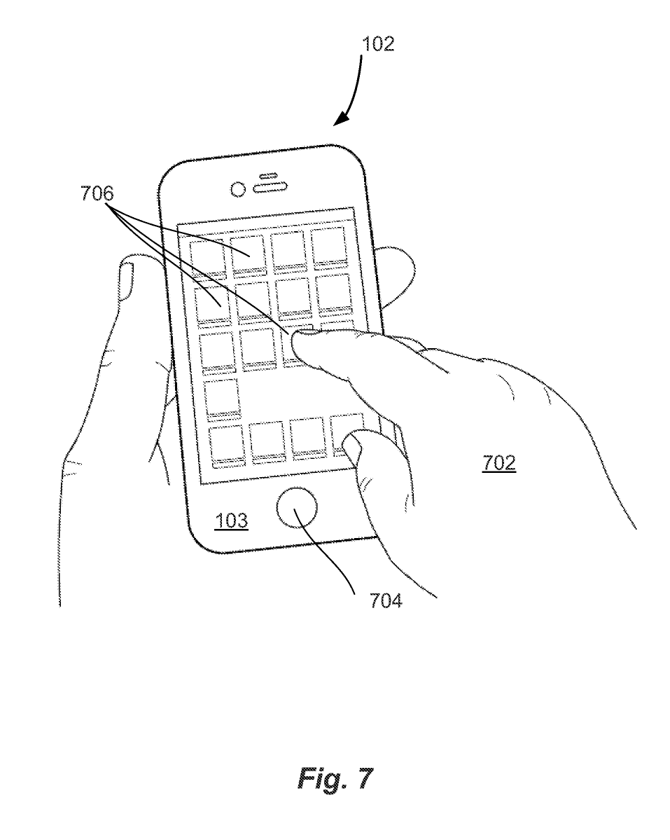

With reference to FIG. 7, the appearance of the smart phone 102 and the standard display screen 103 of the smart phone 102 is shown from the point of view of a smart phone user 702. The appearance of the smart phone screen 103 generally may remain unchanged by the addition of the case 100. A variety of smart phone application software modules 706 are accessible from the standard display screen 103. Optionally, the smart phone 102 may include one or more control buttons (only one illustrated) 704. One or more of the application software modules 706 can be associated with the case 100, for managing selection and wireless communication (e.g., download, upload) of images, logos, graphics, and/or text to be displayed via the photo-reflective dipolar electronic display incorporated into the case 100.

If the image source is the smart phone 102 itself, the communication may simply entail sending the image(s) directly to the circuitry of case 100, for example using a basic container application. If the image source is at a remote location, the application software module 706 associated with the case 100, but executing on the smart phone 102, can manage communications with a remote entity. The remote entity may, for example, take the form of a networked server in a server cloud that is accessible through the Internet, as shown in FIG. 6. For example, the application software module 706, associated with the case 100 but executing on the smart phone 102, can assist in managing a download process.

As previously noted, the download may be a download of licensed content being downloaded from the Internet/Web site server. Also as previously noted, the download may be a download of a user's own personal content being downloaded from the Internet/Web server. Such may include managing financial transactions in which the user 702 purchases a commercial content or even personal content to be displayed on the case 100. Additionally or alternatively, such may include validating authentication with an application-specific integrated circuit (ASIC) included in the integrated circuit module 316. Furthermore, the application software module 706 can adapt or modify image files or other content to be compatible with a particular display employed in the case 100.

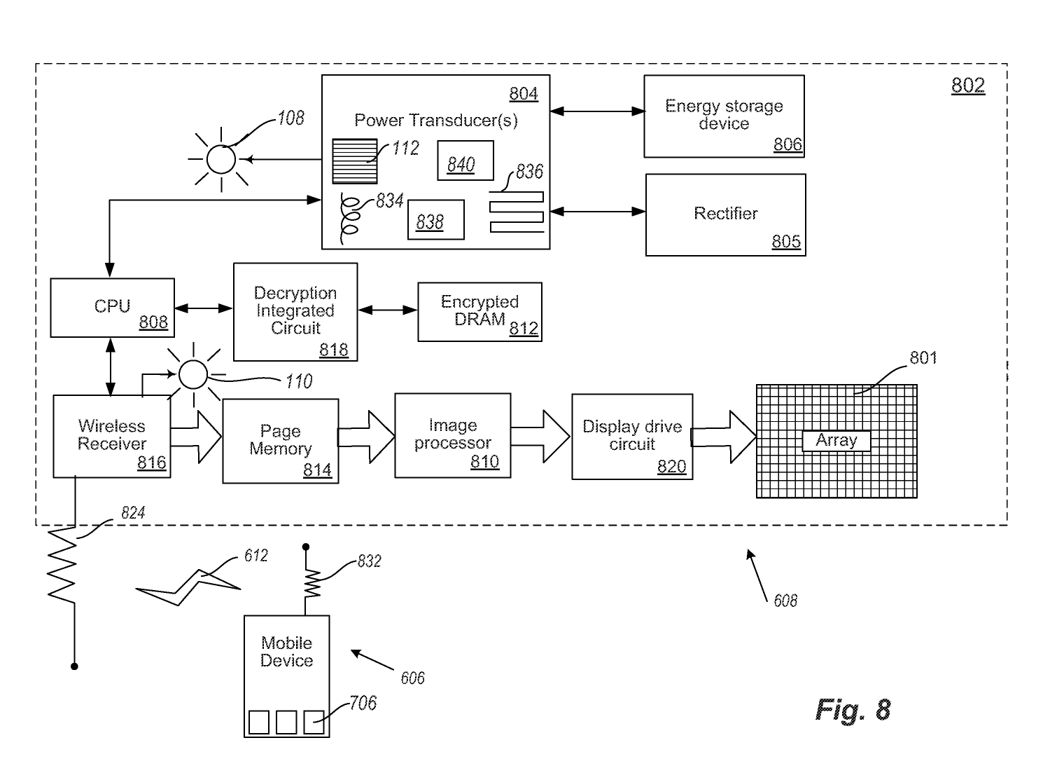

FIG. 8 illustrates electronic and/or electrical components 802 that may be part of the accessory 608, and illustrates wireless communication between the accessory 608 and the processor-based mobile device 606 in more detail.

A primary electronic component within the accessory 608 is an array of photo-reflective elements 801, selectively operable to display one of a number of static images in response to signals that correspond to content (e.g., image data), as described above. In addition, the accessory 608 can further include electronic and/or electrical components that produce or supply electrical power. For example, the accessory 608 may have one or more power transducers 804, rectifiers 805, and/or energy storage devices 806. The accessory may have one or more processors 808, such as a microprocessor (CPU), application specific integrated circuit (ASIC), or programmable gate array (PGA). Optionally, the accessory 608 may have one or more dedicated image processors 810 (only one shown), for example a graphics processing unit (GSP). The accessory 608 may additionally have one or more non-transitory processor-readable storage media 812 and 814 (two shown). The accessory 608 may further have one or more radios 816 (e.g., receiver, transceiver). The accessory 608 may optionally have decryption hardware (e.g., an ASIC) 818, selectively communicatively coupled to the wireless receiver 816. The decryption hardware 818 can be included to provide secure pairing of the accessory 608 to one or more of the application software module(s) 506 executing on the mobile processor-based device 606. Components 802 can further include a display drive circuit 820, an array of photo-reflective elements 822, an accessory RF antenna 824, and the visual indicator lights 108 and 110.

Any one of the electronic and/or electrical components 802 that can be realized in the form of an integrated circuit can be included as a chip component of an integrated circuit module such as the exemplary integrated circuit module 214 shown in FIG. 2. Alternatively, by performing most or all of the image processing functions outside the accessory 608, embodiments of the accessory 608 can include a minimum number of embedded microelectronic and/or electrical components to allow for an ultra-thin, flexible case. Such a flexible case may take the form of an adhesive fabric or film that can be form-fit to the processor-based mobile device 606.

Signal input to the accessory 608 from the processor-based mobile device 606 occurs via the second wireless communication path 612, for example, in response to a user-initiated request. Wireless communications signals (e.g., relatively short range radio frequency (RF) electromagnetic signals, such as Bluetooth® protocol compliant signals) transmitted via the relatively short range wireless communication path 612 by a mobile device RF antenna 832 are received by the accessory RF antenna 824. (One embodiment of the accessory RF antenna 824 is shown and described above as the strip line RF antenna 213). The mobile device RF antenna 832 typically transmits and receives the wireless communications signals 830, whereas the accessory RF antenna 824 in the embodiment shown may only receive the wireless communications signals 830 (i.e., unidirectional communications). However, in some embodiments, the accessory RF antenna 824 can both transmit and receive data (i.e., bidirectional communications). In response, the accessory RF antenna 824 relays the wireless communications signals 830 to the wireless receiver 816.

While the wireless receiver 816 is operating, the connectivity visual indicator light 110 can be selectively actuated by the wireless receiver 816 to indicate to a user that image data is being transferred. The wireless receiver 816 can be programmed to extract content (e.g., image data) from the received signals. Optionally, content (e.g., image data) can be stored in a non-transitory processor-readable storage medium 814 such as a page memory, before transmitting the content (e.g., image data) to the image processor 810.

The image processor 810 optionally arranges (e.g., trims, or otherwise sizes) the received content (e.g., image data) for display on the array of photo-reflective elements 822 via the display drive circuit 820. In some embodiments, cloud-based image processing, including securing copyrighted, proprietary, licensable, or otherwise commercially valuable content (e.g., images), can occur in the content server 602 instead of within the accessory 608.

Content received by the accessory 608 from the processor-based mobile device 606 is intended, in one implementation, to be chosen by, and to be under arbitrary control of, the smart phone user 702. The content (e.g., image data) can be in the form of, for example, personalized content (e.g., image data) provided by the user 702. Such personal content may, for example, be stored on the processor-based mobile device 606. Alternatively, the content (e.g., image data) can correspond to images captured by a camera of a processor-based mobile device 606. Where images are captured in real time or near real time, the image data can be transmitted to the accessory 608 for storage in a storage medium of the accessory 608, in lieu of storage in the memory of the processor-based mobile device 606. The content (e.g., image data) may alternatively take the form of commercial or proprietary content, for example one or more commercial images or advertisements.

The commercial content (e.g., image data) can, for example, originate at the remote content server 602. The commercial content (e.g., image data) can be pushed by the content server 602 to the processor-based mobile device 606 for transmission to the accessory 608. Such may, for example, allow an advertiser or an entity who subsidizes the cost of the processor-based mobile device 606 or service (e.g., cellular service provider) to selectively push advertising to the accessory 608. Alternatively, the commercial content (e.g., image data) can be pulled from the content server 602 by the processor-based mobile device 606. Such may, for example, allow display of content as a function of, or based at least in part on, actual use of the mobile processor-based device 606. For instance, content may be based on a casual game or piece of entertainment media (e.g., music, video, movie, television episode) being played on the mobile processor-based device 606, or which has previously been played.

For example, the commercial content (e.g., image data) can be pushed or pulled in response to, for instance, a purchase transaction in which the user 702 of the processor-based mobile device 606 selects an image from a library of images offered by an Internet-based commercial content provider. The purchase transaction may be a simple fee-for-service transaction, or alternatively, the transaction can be part of a subscription service or an agreement in which advertising or other content is pushed to the accessory 608 as payment for reduced-rate calling or texting privileges, for example. Alternatively, content (e.g., image data) received by the accessory 608 can be generated in accordance with execution of one or more of the application software modules 706 on the processor-based mobile device 606.

The content (e.g., image data) originating at the content server 602 and sent from the processor-based mobile device 606 to the accessory 608 can be encrypted. The processor 808 may execute decryption software to decrypt the encrypted content (e.g., image data). Decryption may employ public-private key pairs, or other techniques for encrypting and decrypting information. Alternatively, the decryption hardware 818, for example in the form of a specialized decryption integrated circuit (e.g., ASIC), can be used to decrypt the encrypted content (e.g., image data). Such may be employed instead of, or in cooperation with, decryption software executed by the processor 808. Alternatively, or additionally, the display drive circuit 820 can perform decryption functions prior to sending drive signals to the array of photo-reflective elements 822 to display images.

A non-transitory processor-readable storage medium, for example dynamic random access memory (DRAM) 812, can store encrypted, partially decrypted, or fully decrypted content (e.g., image data). Such may be stored during or in conjunction with a software-executed, or a hard-wired, decryption procedure. DRAM 812 can simultaneously buffer or hold image data for entire images. In contrast, the page memory 814 can simultaneously buffer or hold image data for only a portion of an image. For example, the page memory 814 may simultaneously buffer or hold only about 20% of the image data at a time. Limiting the size of the buffer may advantageously provide a higher level of data security. For example, if data transfer to or from the buffer is intercepted by an intruder, only a portion of the data will be compromised. One or more power transducers 804 can supply electrical power to the electronic and/or electrical components 802 in the accessory 608. The power transducers 804 harvest energy from one or more sources external to the accessory 608. The power transducers 804 are generally low-power supply devices capable of supplying low voltage levels (e.g., 5V or 12V) suitable for electronic and/or electrical components. The power transducers 804 can include, but are not limited to, the photovoltaic cell panel 112, an inductive coil 834, an RFID-type printed strip line antenna 836, a piezoelectric power device 838, and/or a pyroelectric power device 840. The photovoltaic cell panel 112 is operable to harvest energy from ambient light. The inductive coil 834 and the RFID antenna are operable to harvest energy from signals or carrier waves transmitted by the processor-based mobile device 606 or from other sources ambient electromagnetic radiation. The piezoelectric power device 838 is operable to harness energy from sources of mechanical strain or physical movement such as from human motion or ambient acoustic noise. The pyroelectric power device 840 derives energy from heat or ambient temperature gradients. Some of the power transducers 804 produce AC power that can be converted to DC power by the rectifier 805. The DC power may be supplied directly to the electronic components 802. The DC power may be stepped up or stepped down in voltage via a power converter (e.g., a switch mode power converter) and/or a transformer (e.g., a planar transformer), for directly supplying power to the electronic and/or electrical components 802. Alternatively, DC power can be stored, for supply to the electronic components, in the energy storage device 806. The energy storage device 806 can take the form of, for example, a capacitor or a chemical battery. The power-on visual indicator light 108 can be selectively actuated by the power transducers 804 to indicate when the power transducers 804 are delivering charge either to the energy storage device 806, or directly to the CPU 808 and the other electronic and/or electrical components 802.

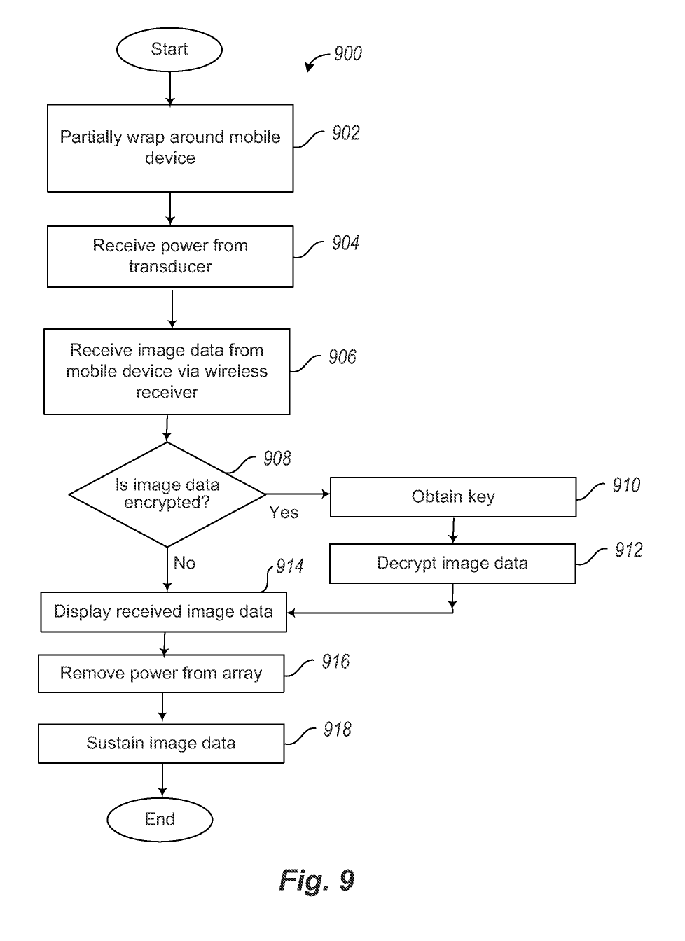

FIG. 9 shows details of a method of operation 900 of the accessory 608, to adjust an external appearance of the mobile processor-based device 608.

At 902, the accessory 608 can be physically coupled to the processor-based mobile device 606. For example, the accessory 708 may at least partially wrap around the mobile processor-based mobile device 606.

At 904, electronic and/or electrical components 802 within the accessory 608 receive electrical power provided by the power transducer(s) 804 and/or stored by energy storage device 806. Switching the accessory 708 from a power-off state or a sleep mode to a power-on state can occur, for instance, in response to a user 702 initiating content transfer via an application software module 706 executing on the mobile processor-based mobile device 606. Alternatively, switching the accessory 608 to a power-on state can occur, for instance, in response to content (e.g., image data) being pushed to the accessory 608.

At 906, the accessory 608 receives content (e.g., image data) from the processor-based mobile device 606 via the wireless receiver 816.

At 908, at least one component of the accessory configuration and support system 600 determines whether or not the received content (e.g., image data) is encrypted. If the content (e.g., image data) is encrypted, at 910 a decryption key is obtained, and at 912, the decryption key is used to decrypt the received image data. The decryption key can be obtained from the content server 702 in advance, for local storage in the memory of the mobile device. Alternatively, the decryption key can be requested from the content server along with each request to download content (e.g., image data). If the received content (e.g., image data) is not encrypted, the received content (e.g., image data) can be displayed at 914 on the array of photo-reflective elements 822.

At 916, power may be removed from the array of photo-reflective elements 822 while the array continues to sustain display of the image defined by the image data at 918.

The foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via application-specific integrated circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

Those of skill in the art will recognize that many of the methods or algorithms set out herein may employ additional acts, may omit some acts, and/or may execute acts in a different order than specified.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer medium.

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification, including U.S. provisional patent application Ser. No. 61/735,508 are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An accessory for processor-based mobile devices, the accessory comprising:
a body that is selectively securely attachable to a processor-based mobile device;
a photo-reflective dipolar electronic display carried by the body and which in use at least partially wraps about at least one edge of the processor-based mobile device;
a wireless receiver and at least one antenna carried by the body, the wireless receiver operable to at least receive wireless communications from the processor-based mobile device at least when the body is securely attached to the processor-based mobile device, the wireless communications including image data for display via the photo-reflective dipolar electronic display;
a drive circuit communicatively coupled between the wireless receiver and the photo-reflective dipolar electronic display to at least drive the photo-reflective dipolar electronic display in response to received image data; and
a power transducer carried by the body and electrically coupled to supply power to at least one of the drive circuit or the photo-reflective dipolar electronic display and which receives power from a source external from the accessory.

2. The accessory of claim 1 wherein the body is a resilient silicone sleeve.

3. The accessory of claim 2 wherein at least the wireless receiver and the drive circuit are encapsulated in the resilient silicone sleeve.

4. The accessory of claim 2, further comprising:
a hard shell case that is received about a portion of the resilient silicone sleeve and the processor-based mobile device.

5. The accessory of claim 1 wherein the body is a hard shell case having a base and a number of resilient portions extending from the base.

6. The accessory of claim 5 wherein at least the wireless receiver and the drive circuit are encapsulated in the hard shell case.

7. The accessory of claim 5, further comprising:
a resilient silicone sleeve that is resiliently secured to about a portion of the processor-based mobile device, and about which the hard shell case is at least partially received.

8. The accessory of claim 1 wherein the power transducer includes at least one photovoltaic cell to harvest energy from light in an ambient environment.

9. The accessory of claim 8 wherein the body has a base and a number of sides extending at least approximately from the base which deliminate an interior of the body, and the at least one photovoltaic cell is positioned in the interior of the body.

10. The accessory of claim 1 wherein the power transducer includes a rectifier circuit and a capacitor, coupled to the antenna to harvest energy from the wireless communications transmitted via the processor-based mobile device.

11. The accessory of claim 1 wherein the power transducer includes an inductive coil to inductively receive power from the processor-based mobile device.

12. The accessory of claim 1 wherein the photo-reflective dipolar electronic display is an e-paper display which retains an image for an extended period of time without drawing electrical power.

13. The accessory of claim 2, further comprising
a decryption integrated circuit communicatively coupled to the wireless receiver to decrypt the signals received via the wireless receiver.

14. A method of adjusting an external appearance of a processor-based mobile device, the method comprising:
partially wrapping around at least one edge of the processor-based mobile device, and including a power transducer, a drive circuit, a wireless receiver, and an antenna;
receiving power from a source external to the accessory, via the power transducer;
receiving image data from the mobile device via the antenna and wireless receiver;
displaying the received image data on an array of photo-reflective dipolar electronic elements carried by the accessory, in response to signals from the drive circuit, when power is applied to the array by the power transducer; and
sustaining the image data on the array of photo-reflective dipolar electronic elements after power is removed from the array.

15. The method of claim 14 wherein the receiving includes receiving encrypted image data from the mobile device via the antenna and wireless receiver, and further comprising decrypting the image data via an integrated circuit of the accessory.

16. The method of claim 14 wherein the receiving image data from the mobile device includes receiving personalized image data provided by a user.

17. The method of claim 14 wherein the receiving image data includes receiving image data captured using a camera of the mobile device.

18. The method of claim 14 wherein the receiving image data includes receiving image data via an application executing on the mobile device.

19. The method of claim 14 wherein the receiving image data includes receiving advertising image data pushed to the mobile device.

20. The method of claim 14 wherein the receiving image data includes receiving advertising image data pulled to the mobile device.
